(19) United States
(12) Patent Application Publication
(10) Pub. No.: US 2013/0138330 A1
(43) Pub. Date: May 30, 2013

(54) SYSTEM AND METHOD TO OPTIMIZE MASS TRANSPORT VEHICLE ROUTING BASED ON TON-MILE COST INFORMATION

(71) Applicants: JIEFENG XU, Alpharetta, GA (US); Ajesh Kapoor, Marietta, GA (US); Amit Maheshwari, Bellevue, WA (US)

(72) Inventors: JIEFENG XU, Alpharetta, GA (US); Ajesh Kapoor, Marietta, GA (US); Amit Maheshwari, Bellevue, WA (US)

(21) Appl. No.: 13/304,420

(22) Filed: Nov. 25, 2011

(51) Int. Cl. G08G 1/00

(52) U.S. Cl. 701/117

(57) ABSTRACT

A system and method to optimize mass transport vehicle routing based on additional ton-mile cost information are disclosed. In one embodiment, a starting location and a plurality of customer locations associated with a warehouse and a plurality of customers, respectively, are identified. Furthermore, a plurality of pairs of locations is identified using the starting location and plurality of customer locations. Mileage cost information and ton-mile cost information are then dynamically computed for each of the plurality of pairs of locations. In addition, sets of mass transport vehicle routes between the starting location and plurality of customer locations are dynamically determined using the pairs of locations and a number of vehicles to be used. Moreover, trip cost information is computed, in real-time, for each set of mass transport vehicle routes. Also, an optimized set of mass transport vehicle routes is determined, in real-time, using the trip cost information.

### TECHNICAL FIELD

Embodiments of the present subject matter relate to a transport management system (TMS). More particularly, embodiments of the present subject matter relate to optimizing mass transport vehicle routing in the TMS.

### BACKGROUND

Typically, transportation of commercial and industrial goods is a main feature of trucking industries. Today's trucking industries have been under pressure due to problems, such as spiking fuel prices and effects of global warming and green house gas (GHG) emissions. Further, many countries have imposed a carbon tax and an environmental tax that are based on carbon content in fuel to impose restriction on fuel consumption during the transportation of commercial and industrial goods. To improve fuel efficiency and to reduce the GHG emissions, the trucking industries have implemented many newer technologies to boost vehicle performance and to reduce the carbon content in the fuel. However, the newer techniques require considerable investment as they typically require purchasing newer vehicle equipments and higher grade fuels. One approach used by the trucking industry to solve this problem is to reduce distance travelled by a vehicle using smart routing.

Typically, most of the trucking industries rely on using a transportation management system (TMS) to manage trucking operations, such as delivering merchandise and the like to reduce the distance travelled by the vehicles. A computerized routing engine in the TMS is used to optimize vehicle route by minimizing cost associated with the distance travelled by the vehicle. The optimized vehicle routing enables reduction in consumption of the fuel and consequently the GHG emissions. However, the optimized vehicle route does not take into consideration the global warming and the GHG emissions. One way to overcome this problem is to use a time dependent vehicle routing model to provide optimized routes by considering traffic congestion to direct the vehicles away from the traffic congestion. Such vehicle routing models use mileage cost information for vehicle routing. However, using the mileage cost information for the vehicle routing may not result in determining optimal vehicle routes in term of minimizing the fuel consumption.

### SUMMARY

A system and method to optimize mass transport vehicle routing based on additional ton-mile cost information are disclosed. According to one aspect of the present subject matter, order information, fleet information and company work rules and regulations are received by a mass transport vehicle routing engine running on a computer. A starting location and a plurality of customer locations associated with a warehouse and a plurality of customers, respectively, are then identified by the mass transport vehicle routing engine running on the computer. The plurality of customer locations associated with the plurality of customers is identified from the received order information. A plurality of pairs of locations is then identified using the starting location and plurality of customer locations by the mass transport vehicle routing engine running on the computer. Mileage cost information and ton-mile cost information are then dynamically computed for each of the plurality of pairs of locations by the mass transport vehicle routing engine running on the computer.

Further, sets of mass transport vehicle routes between the starting location and the plurality of customer locations are dynamically determined by the mass transport vehicle routing engine running on the computer using the plurality of pairs of locations and a number of vehicles to be used. Trip cost information for each set of mass transport vehicle routes is then computed, in real-time, using the mileage cost information and the ton-mile cost information by the mass transport vehicle routing engine running on the computer. Also, an optimized set of mass transport vehicle routes is determined, in real-time, from the sets of mass transport vehicle routes using the computed trip cost information by the mass transport vehicle routing engine running on the computer. Moreover, real-time disruption information associated with the optimized set of mass transport vehicle routes is received by the mass transport vehicle routing engine running on the computer. A further optimized set of mass transport vehicle routes is then obtained using the real-time disruption information by the mass transport vehicle routing engine running on the computer.

According to another aspect of the present subject matter, a transport management system (TMS) includes a processor, memory coupled to the processor, and the mass transport vehicle routing engine residing in the memory. Further, the mass transport vehicle routing engine includes an order information module, a fleet information module and a company work rules and regulations module to store order information, fleet information and company work rules and regulations, respectively. Furthermore, the mass transport vehicle routing engine includes a location identification module to identify the starting location and the plurality of customer locations associated with the warehouse and the plurality of customers, respectively. The plurality of customer locations associated with the plurality of customers is identified from the received order information. In addition, the mass transport vehicle routing engine includes a location pair identification module to identify a plurality of pairs of locations using the starting location and the plurality of customer locations. Also, the mass transport vehicle routing engine includes a mileage cost matrix module to dynamically compute mileage cost information for each of the plurality of pairs of locations. Moreover, the mass transport vehicle routing engine includes a ton-mile cost matrix module to dynamically compute ton-mile cost information for each of the plurality of pairs of locations.

Further, the mass transport vehicle routing engine includes a mass transport vehicle routes planning engine to dynamically determine sets of mass transport vehicle routes between the starting location and the plurality of customer locations using the plurality of pairs of locations and a number of vehicles to be used. Furthermore, the mass transport vehicle routes planning engine computes, in real-time, trip cost information for each set of mass transport vehicle routes using the mileage cost information and ton-mile cost information. In addition, the mass transport vehicle routes planning engine determines, in real-time, an optimized set of mass transport vehicle routes from the sets of mass transport vehicle routes using the computed trip cost information.

According to yet another aspect of the present subject matter, a non-transitory computer-readable storage medium for optimizing the mass transport vehicle routing based on the ton-mile cost information having instructions that, when executed by a computing device, cause the computing device to perform the method described above.

The system and method disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 illustrates a flowchart of a computer implemented method to optimize mass transport vehicle routing based on additional ton-mile cost information, according to one embodiment;

FIG. 2 illustrates a flowchart of a method to optimize mass transport vehicle routing based on the additional ton-mile cost information during a planning stage, according to one embodiment;

FIG. 3 illustrates a flowchart of a method to optimize mass transport vehicle routing based on the additional ton-mile cost information during an execution stage, according to one embodiment;

FIG. 4 illustrates a block diagram of a mass transport vehicle routing engine for optimizing mass transport vehicle routing based on the additional ton-mile cost information, using the process shown in FIG. 1, according to one embodiment;

FIG. 5 illustrates an exemplary transportation network for which an optimized set of mass transport vehicle routes is determined, using the process shown in FIG. 1, according to one embodiment;

FIG. 6 illustrates another exemplary transportation network for which an optimized set of mass transport vehicle routes is determined, using the process shown in FIG. 1, according to one embodiment; and

FIG. 7 illustrates a transport management system (TMS) including the mass transport vehicle routing engine, such as the one shown in FIG. 4, to optimize the mass transport vehicle routing based on the additional ton-mile cost information, using the process shown in FIG. 1, according to one embodiment.

The systems and methods disclosed herein may be implemented in any means for achieving various aspects. Other features will be apparent from the accompanying drawings and from the detailed description that follow.

### DETAILED DESCRIPTION

A system and method to optimize mass transport vehicle routing based on additional ton-mile cost information are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

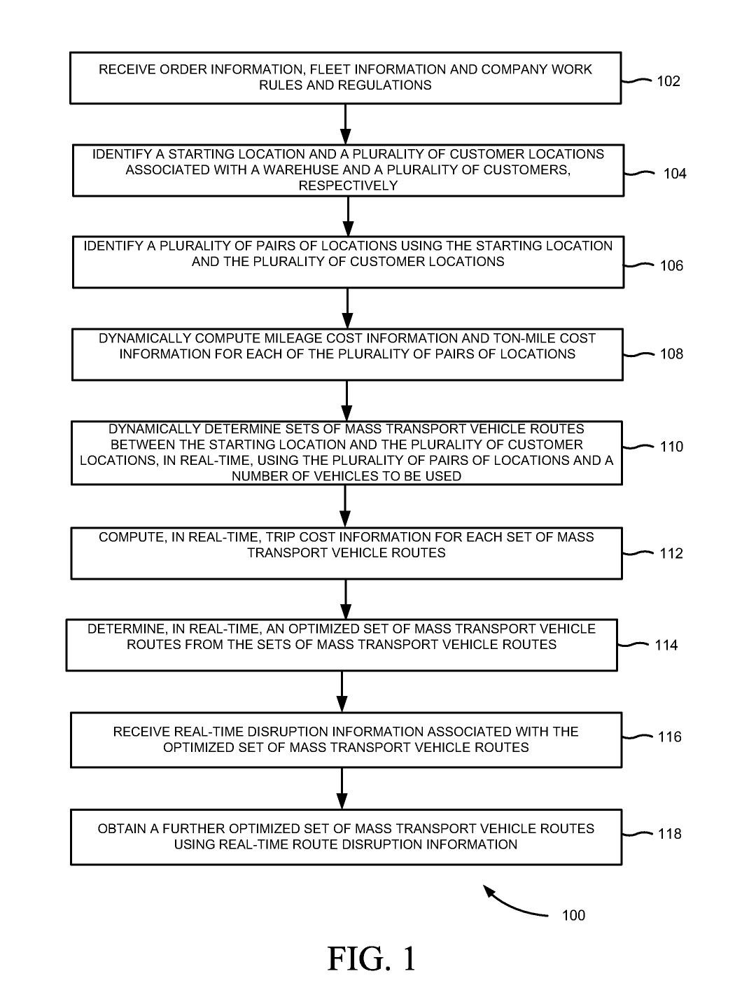

FIG. 1 illustrates a flowchart 100 of a computer implemented method to optimize mass transport vehicle routing based on additional ton-mile cost information, according to one embodiment. At block 102, order information, fleet information and company work rules and regulations are received by a mass transport vehicle routing engine running on the computer. The order information includes a time limit, a customer order, a customer address and the like associated with a plurality of customers. Exemplary fleet information includes a number of available vehicles, vehicle characteristics and the like. For example, the vehicle characteristics include a vehicle energy type based on energy consumption, a vehicle class (e.g., a commercial truck or a trailer), a vehicle size, a vehicle weight (e.g., an unloaded vehicle or a loaded vehicle, an estimated weight or an actual weight), a vehicle capacity, a vehicle energy function, a vehicle maintenance history, and the like.

At block 104, a starting location and a plurality of customer locations associated with a warehouse and the plurality of customers, respectively, are obtained by the mass transport vehicle routing engine running on the computer. In one embodiment, the plurality of customer locations associated with the plurality of customers is identified from the received order information. Particularly, the plurality of customer locations associated with the plurality of customers is identified from the associated customer address. At block 106, a plurality of pairs of locations is identified using the starting location and the plurality of customer locations by the mass transport vehicle routing engine running on the computer. At block 108, mileage cost information and ton-mile cost information are dynamically computed for each of the plurality of pairs of locations by the mass transport vehicle routing engine running on the computer. In one embodiment, the ton-mile cost information is cost information associated with distance travelled by a vehicle and net weight of load carried by the vehicle over the distance.

At block 110, sets of mass transport vehicle routes are dynamically determined between the starting location and the plurality of customer locations, by the mass transport vehicle routing engine running on the computer, using the plurality of pairs of locations and a number of vehicles to be used. For example, each set of mass transport vehicle routes includes one or more mass transport vehicle routes based on the number of vehicles to be used. Further, each set of mass transport vehicle routes includes the one or more mass transport vehicle routes that cover the plurality of customer locations using the number of vehicles. In one embodiment, the number of vehicles to be used is dynamically computed by the mass transport vehicle routing engine using the number of available vehicles. In another embodiment, the number of vehicles to be used is provided by a user.

At block 112, trip cost information is computed, in real-time, for each set of mass transport vehicle routes using the mileage cost information and ton-mile cost information by the mass transport vehicle routing engine running on the computer. The trip cost information for each set of mass transport vehicle routes is computed using an equation:

trip cost information=mileage cost information+k*(ton-mile cost information) where k is a weight constant.

At block 114, an optimized set of mass transport vehicle routes is determined, in real-time, from the sets of mass transport vehicle routes using the computed trip cost information by the mass transport vehicle routing engine running on the computer. In one embodiment, a first set of mass transport vehicle routes and a second set of mass transport vehicle routes are selected from the sets of mass transport vehicle routes by a mass transport vehicle routing engine running on the computer. Further, the trip cost information associated with the first set of mass transport vehicle routes and the second set of mass transport vehicle routes are obtained by a mass transport vehicle routing engine running on the computer. Furthermore, the trip cost information associated with the first set of mass transport vehicle routes is compared with the trip cost information associated with the second set of mass transport vehicle routes by the mass transport vehicle routing engine running on the computer. In addition, one of the first set of mass transport vehicle routes and second set of mass transport vehicle routes associated with minimum of the trip cost information is declared as an optimized set of mass transport vehicle routes based on the comparison by the mass transport vehicle routing engine running on the computer. Also, the steps of selecting, obtaining, comparing and declaring are repeated for a next set of mass transport vehicle routes and the optimized set of mass transport vehicle routes by a mass transport vehicle routing engine running on the computer. The above steps are repeated until the determined sets of mass transport vehicle routes are compared and the optimized set of mass transport vehicle routes is identified.

At block 116, real-time disruption information associated with the optimized set of mass transport vehicle routes are obtained by the mass transport vehicle routing engine running on the computer. Exemplary real-time disruption information includes real-time order information, traffic information, accident information, fuel cost, vehicle conditions, conditions associated with the plurality of customer locations and the like. At block 118, a further optimized set of mass transport vehicle routes is obtained using the real-time disruption information by the mass transport vehicle routing engine running on the computer. In one embodiment, the starting location and the plurality of customer locations associated with the warehouse and the plurality of customers, respectively, are obtained in real-time, by the mass transport vehicle routing engine running on the computer, based on the real-time disruption information. In this embodiment, the plurality of customer locations associated with the plurality of customers is identified from the received real-time order information. Particularly, the plurality of customer locations associated with the plurality of customers is identified from the associated customer address. Further, the plurality of pairs of locations is identified, in real-time, using the starting location and the plurality of customer locations, by the mass transport vehicle routing engine running on the computer, based on the real-time disruption information. In addition, the further optimized set of mass transport vehicle routes is obtained using the real-time disruption.

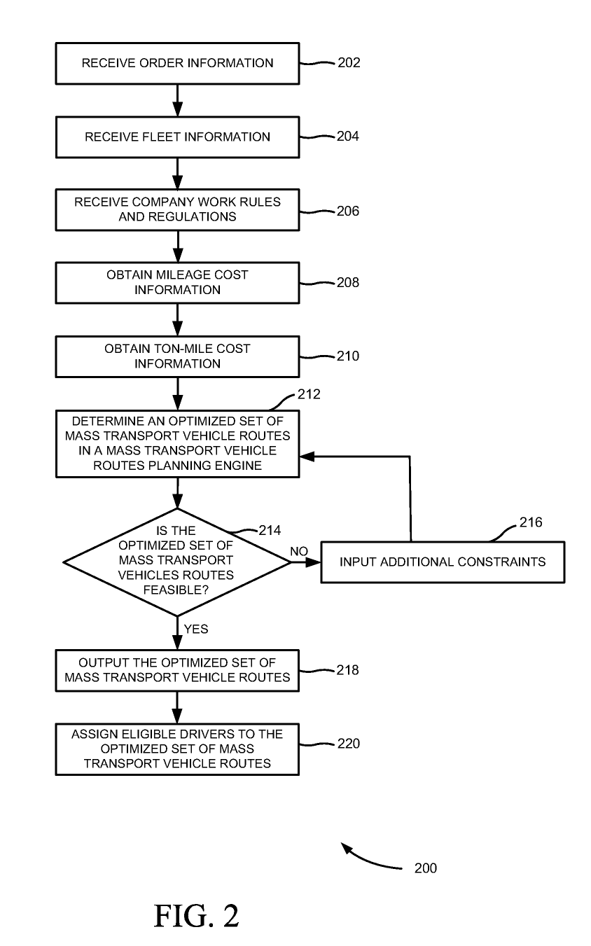

Referring now to FIG. 2, which is a flowchart 200 that illustrates a method to optimize mass transport vehicle routing based on additional ton-mile cost information during a planning stage, according to one embodiment. At block 202, order information associated with a plurality of customers is received. For example, the order information includes a time limit, a customer order, a customer address and the like. At block 204, fleet information is received. For example, the fleet information includes a number of available vehicles, vehicle characteristics and the like. For example, the vehicle characteristics include a vehicle energy type based on energy consumption, a vehicle class (e.g., a commercial truck or a trailer), a vehicle size, a vehicle weight (e.g., an unloaded vehicle or a loaded vehicle, an estimated weight or actual weight), a vehicle capacity, a vehicle energy function, a vehicle maintenance history, and the like. At block 206, company work rules and regulations are received.

At block 208, mileage cost information for each of a plurality of pairs of locations is obtained by a mass transport vehicle routes planning engine. In one embodiment, a starting location and a plurality of customer locations associated with a warehouse and the plurality of customers, respectively, are obtained. For example, the plurality of locations is identified from the received order information. Particularly, the plurality of locations is identified from the associated customer address. Further, the plurality of pairs of locations is identified using the starting location and the plurality of customer locations. Furthermore, the mileage cost information is computed for each of the plurality of pairs of locations. In addition, the mileage cost information for each of the plurality of pairs of locations is obtained by the mass transport vehicle routes planning engine.

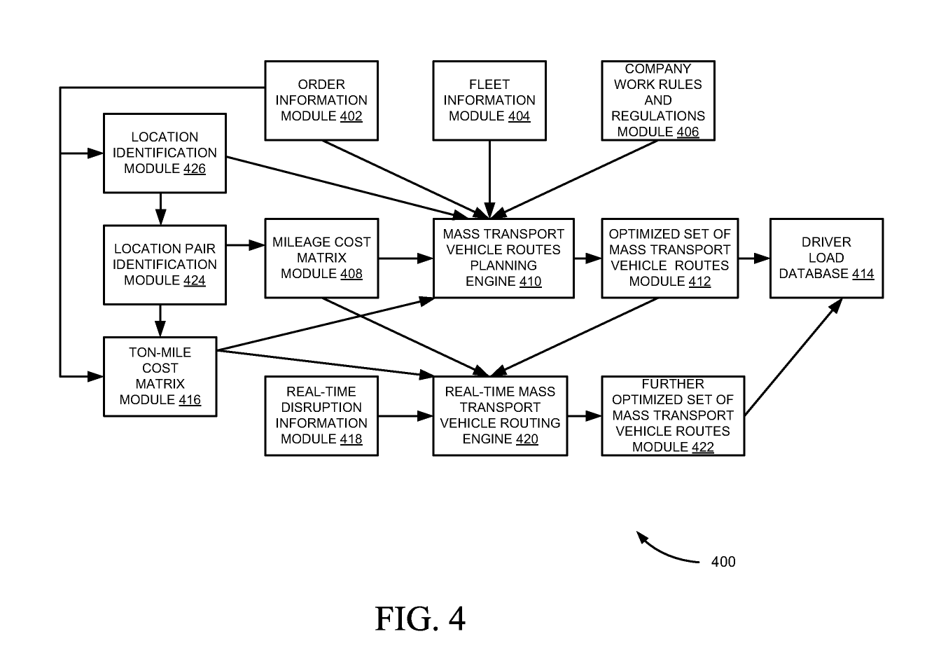

At block 210, ton-mile cost information is obtained for each of the plurality of pairs of locations by the mass transport vehicle routes planning engine. In one embodiment, the ton-mile cost information is computed for each of the plurality of pairs of locations. In addition, the ton-mile cost information for each of the plurality of pairs of locations is obtained by the mass transport vehicle routes planning engine. At block 212, an optimized set of mass transport vehicle routes is determined by the mass transport vehicle routes planning engine. In one embodiment, during the planning stage, the order information is received beforehand, usually a few days before execution stage. When the order information is received by a mass transport vehicle routing engine, mass transport vehicle routes planning engine determines an optimized set of mass transport vehicle routes based on the ton-mile cost information. This is explained in more detail with reference to FIG. 4.

At block 214, it is determined whether the optimized set of mass transport vehicle routes is feasible. In other words, a user determines whether the optimized set of mass transport vehicle route is implementable. For example, the user determines whether the optimized set of mass transport vehicle routes is implementable based on varieties of merchandise to be carried by vehicles, a number of customers served by a vehicle in a mass transport vehicle route and the like. At block 216, additional constraints are input to the mass transport vehicle routes planning engine to obtain a new optimized set of mass transport vehicle routes if the optimized set of mass transport vehicle routes is not feasible. In one example, if the optimized set of mass transport vehicle routes is not feasible, the user inputs the additional constraints to prevent generation of the optimized set of mass transport vehicle routes in re-run of the mass transport vehicle routes planning engine. Exemplary additional constraints include “customer locations not to be served by a vehicle”, “a threshold number of customers to be served by a vehicle” and the like. At block 218, the optimized set of mass transport vehicle routes is output if the optimized set of mass transport vehicle routes is feasible. At block 220, eligible drivers are assigned to the optimized set of mass transport vehicle routes.

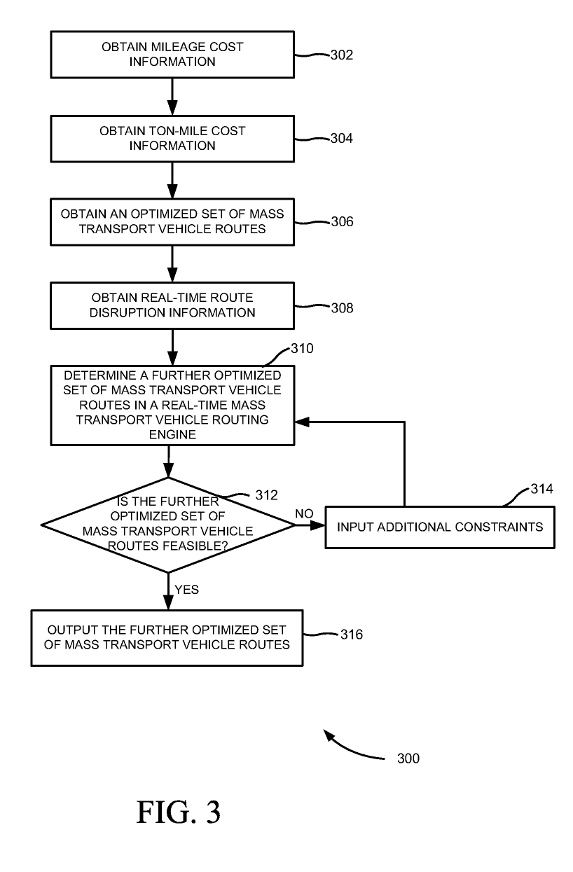

Referring now to FIG. 3, which is a flowchart 300 that illustrates a method to optimize mass transport vehicle routing based on additional ton-mile cost information during an execution stage, according to one embodiment. At block 302, mileage cost information is obtained for each of a plurality of pairs of locations. This is explained in more detail with reference to FIG. 2. At block 304, the ton-mile cost information is obtained for each of the plurality of pairs of locations. This is explained in more detail with reference to FIG. 2.

At block 306, an optimized set of mass transport vehicle routes, such as the one explained in FIG. 2, is obtained by a real-time mass transport vehicle routing engine. At block 308, real-time disruption information associated with the optimized set of mass transport vehicle routes is obtained. Exemplary real-time disruption information includes real-time order information, traffic information, accident information, fuel cost, vehicle conditions, conditions associated with the plurality of customer locations and the like. In one embodiment, during the execution stage, real-time disruption information is obtained by the real-time mass transport vehicle routing engine. At block 310, a further optimized set of mass transport vehicle routes is obtained by the real-time mass transport vehicle routing engine. In one example, the real-time mass transport vehicle routing engine accommodates real-time order information and modifies the optimized set of mass transport vehicle routes, or repairs the optimized set of mass transport vehicle routes to obtain the further optimized and feasible set of mass transport vehicle routes based on the real-time disruption information.

At block 312, it is determined whether the further optimized set of mass transport vehicle routes is feasible. In other words, a user determines whether the further optimized set of mass transport vehicle route is implementable. For example, the user determines whether the further optimized set of mass transport vehicle route is implementable based on varieties of merchandise to be carried by vehicles, a number of customers served by vehicle in a mass transport vehicle route and the like. At block 314, additional constraints are input to the real-time mass transport vehicle routing engine to obtain a new optimized set of mass transport vehicle routes if the further optimized set of mass transport vehicle routes is not feasible. In one example, if the further optimized set of mass transport vehicle routes is not feasible, the user inputs the additional constraints to prevent generation of the optimized set of mass transport vehicle routes in re-run of the real-time mass transport vehicle routing engine. Exemplary additional constraints include “customer locations not to be served by a vehicle”, “a threshold number of customers to be served by a vehicle” and the like. At block 316, the further optimized set of mass transport vehicle routes is output if the further optimized set of mass transport vehicle routes is feasible.

Referring now to FIG. 4, which illustrates a block diagram of a mass transport vehicle routing engine 400 for optimizing mass transport vehicle routing based on the additional ton-mile cost information, using the process shown in FIG. 1, according to one embodiment. As shown in FIG. 4, the mass transport vehicle routing engine 400 includes an order information module 402, a fleet information module 404, a company work rules and regulations module 406, a mileage cost matrix module 408, a mass transport vehicle routes planning engine 410, an optimized set of mass transport vehicle routes module 412, a driver load database 414, a ton-mile cost matrix module 416, a real-time disruption information module 418, a real-time mass transport vehicle routing engine 420, a further optimized set of mass transport vehicle routes module 422, a location pair identification module 424 and a location identification module 426.

Further as shown in FIG. 4, the fleet information module 404, the company work rules and regulations module 406 are coupled to the mass transport vehicle routes planning engine 410. Furthermore, the order information module 402 is coupled to the location identification module 426 and the mass transport vehicle routes planning engine 410. In addition, the location identification module 426 is coupled to the location pair identification module 424. Also, the location pair identification module 424 is coupled to the mileage cost matrix module 408, the ton-mile cost matrix module 416 and the mass transport vehicle routes planning engine 410. Moreover, the mileage cost matrix module 408 and the ton-mile cost matrix module 416 are coupled to the mass transport vehicle routes planning engine 410 and the real-time mass transport vehicle routing engine 420.

Further, the mass transport vehicle routes planning engine 410 is coupled to the optimized set of mass transport vehicle routes module 412. Furthermore, the optimized set of mass transport vehicle routes module 412 is coupled to the driver load database 414. In addition, the real-time disruption information module 418 is coupled to the real-time mass transport vehicle routing engine 420. Also, the real-time mass transport vehicle routing engine 420 is coupled to the further optimized set of mass transport vehicle routes engine 422. Moreover, the further optimized set of mass transport vehicle routes engine 422 is coupled to the driver load database 414.

In one embodiment, the fleet information module 404 includes fleet information, such as a number of available vehicles, vehicle characteristics and the like. For example, the vehicle characteristics include a vehicle energy type based on energy consumption, a vehicle class (e.g., a commercial truck or a trailer), a vehicle size, a vehicle weight (e.g., an unloaded vehicle or a loaded vehicle, an estimated weight or an actual weight), a vehicle capacity, a vehicle energy function, a vehicle maintenance history, and the like. Further, the order information module includes order information, such as a time limit, a customer order, and a customer address associated with the plurality of customers. Furthermore, the company work rules and regulations module 406 includes rules and regulations of the company.

In operation, the location identification module 426 identifies a starting location and a plurality of customer locations associated with a warehouse and the plurality of customers, respectively. For example, the plurality of customer locations is identified by the location identification module 426 from the order information. Particularly, the plurality of customer locations is identified by the location identification module 426 from associated customer address. Further, the location pair identification module 424 identifies a plurality of pairs of locations using the starting location and the plurality of customer locations. Furthermore, the mileage cost matrix module 408 dynamically computes mileage cost information for each of the plurality of pairs of locations. This is explained in more detail with reference to FIGS. 1 and 2. Also, the ton-mile cost matrix module 416 dynamically computes ton-mile cost information for each of the plurality of pair of locations. The ton-mile cost information is cost information associated with distance travelled by a vehicle and net weight of load carried by the vehicle over the distance. This is explained in more detail with reference to FIGS. 1 and 2.

Further, the mass transport vehicle routes planning engine 410 receives the order information, the fleet information, the company work rules and regulations, the mileage cost information and the ton-mile cost information from the order information module 402, fleet information module 404, company work rules and regulations module 406, mileage cost matrix module 408 and ton-mile cost matrix module 416. Furthermore, the mass transport vehicle routes planning engine 410 dynamically determines sets of mass transport vehicle routes between the starting location and the plurality of customer locations using the plurality of pairs of locations and a number of vehicles to be used. In one embodiment, each set of mass transport vehicle routes includes one or more mass transport vehicle routes based on the number of vehicles to be used. Further, each set of mass transport vehicle routes includes one or more mass transport vehicle routes that cover the plurality of customer locations using the number of vehicles. In one embodiment, the number of vehicles to be used is dynamically computed by the mass transport vehicle routing engine using the number of available vehicles. In another embodiment, the number of vehicles to be used is provided by a user. Furthermore, the mass transport vehicle routes planning engine 410 computes, in real-time, trip cost information for each set of mass transport vehicle routes using the mileage cost information and ton-mile cost information. The trip cost information for each set of mass transport vehicle routes is computed using an equation:

trip cost information=mileage cost information+k*(ton-mile cost information) where k is a weight constant.

In addition, the mass transport vehicle routes planning engine 410 determines, in real-time, an optimized set of mass transport vehicle routes from the sets of mass transport vehicle routes using the computed trip cost information. In one embodiment, the mass transport vehicle routes planning engine 410 selects a first set of mass transport vehicle routes and a second set of mass transport vehicle routes from the sets of mass transport vehicle routes. The mass transport vehicle routes planning engine 410 then obtains trip cost information associated with the first set of mass transport vehicle routes and the second set of mass transport vehicle routes. Further, the mass transport vehicle routes planning engine 410 compares the trip cost information associated with the first set of mass transport vehicle routes with the trip cost information associated with the second set of mass transport vehicle routes. Furthermore, the mass transport vehicle routes planning engine 410 declares one of the first set of mass transport vehicle routes and second set of mass transport vehicle routes associated with minimum of the trip cost information as an optimized set of mass transport vehicle routes based on the comparison. The above steps are repeated until the determined sets of mass transport vehicle routes are compared and the optimized set of mass transport vehicle routes is identified.

Also, the mass transport vehicle routes planning engine 410 repeats the steps of selecting, obtaining, comparing and declaring for a next mass transport vehicle routes in the sets of mass transport vehicle routes and the optimized set of mass transport vehicle routes. For example, the mass transport vehicle routes planning engine 410 uses a tabu search method to determine the optimized set of mass transport vehicle routes.

Further, the mass transport vehicle routes planning engine 410 stores the optimized set of mass transport vehicle routes in the optimized set of mass transport vehicle routes module 412. Furthermore, the optimized set of mass transport vehicle routes module 412 sends the optimized set of mass transport vehicle routes to the driver load database 414. This is explained in more detail with reference to FIG. 2. In one embodiment, the real-time mass transport vehicle routing engine 420 obtains real-time disruption information, such as traffic information, accident information, real-time order information, vehicle conditions, fuel cost, conditions associated with the plurality of customer locations and the like from the real-time disruption information module 418. The real-time mass transport vehicle routing engine 420 then obtains a further optimized set of mass transport vehicle routes using the real-time disruption information.

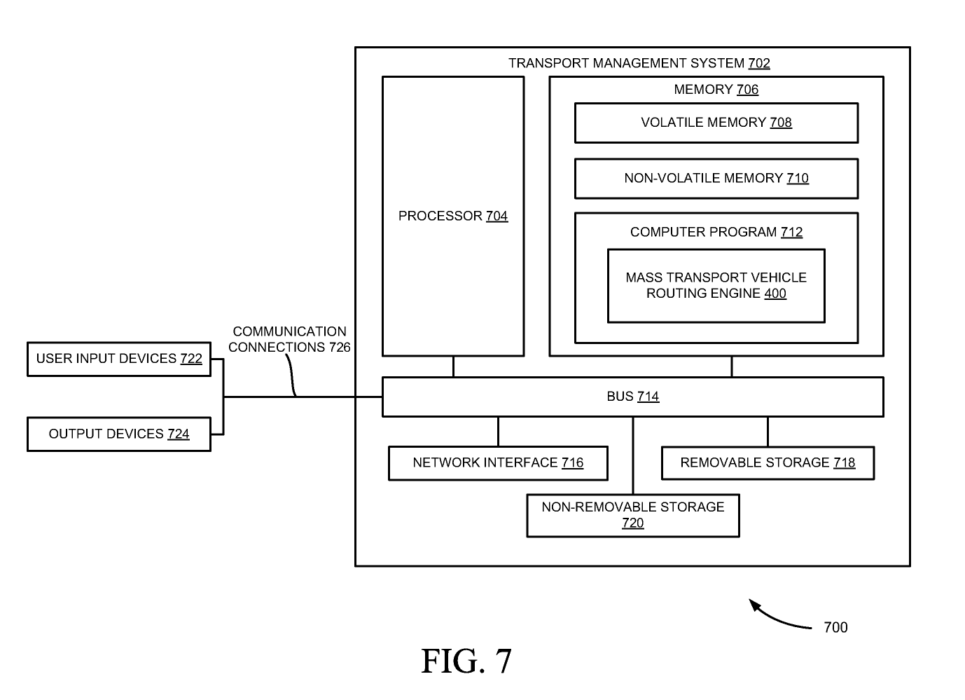

In one embodiment, the location identification module 426 identifies, in real-time, the starting location and the plurality of customer locations associated with the warehouse and the plurality of customers, respectively, based on the real-time disruption information. For example, the plurality of customer locations is identified by the location identification module 426 from the real-time order information. Particularly, the plurality of customer locations is identified by the location identification module 426 from associated customer address. Further, the location pair identification module 424 identifies, in real-time, the plurality of pairs of locations using the starting location and the plurality of customer locations based on the real-time disruption information. This is explained in more detail with reference to FIG. 3. In one embodiment, the method of optimizing mass transport vehicle routing requires using a computing system (e.g., a transport management system 702 of FIG. 7) of because of a huge number of possible mass transport vehicle routes. For example, a simple scenario including 10 customers served by a single vehicle can result in 3628800 possible mass transport vehicle routes. Further, the real-time mass transport vehicle routing engine 420 stores the further optimized set of mass transport vehicle routes in the further optimized set of mass transport vehicle routes module 422. Furthermore, the further optimized set of mass transport vehicle routes module 422 sends the further optimized set of mass transport vehicle routes to the driver load database 414.

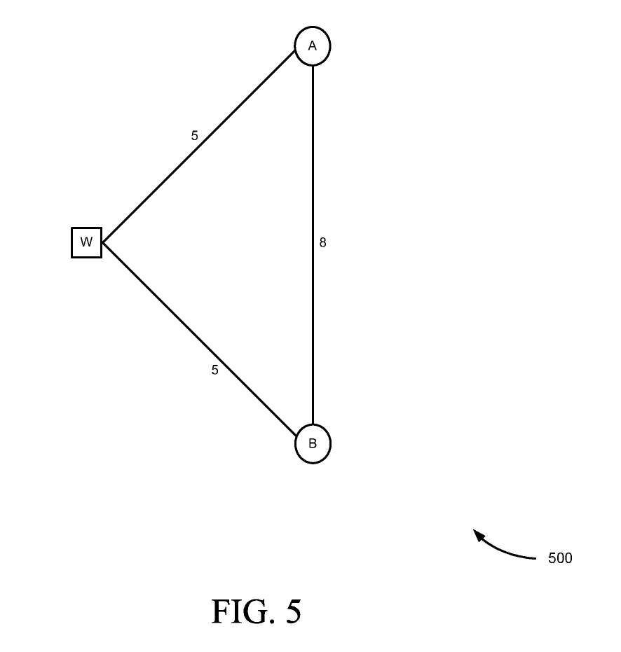

Referring now to FIG. 5, which illustrates an exemplary transportation network 500 for which an optimized set of mass transport vehicle route is determined, using the process shown in FIG. 1, according to one embodiment. As shown in FIG. 5, two customers (A and B) require merchandise from a warehouse (W). Further as shown in FIG. 5, distance between W and A is 5 miles. Furthermore, distance between A and B is 8 miles. In addition, distance between B and W is 5 miles. In this embodiment, one vehicle is used for transportation of the merchandise from W to A and B. Further, customer orders from A and B are 500 pounds (lb) and 1000 lb, respectively.

In operation, a plurality of pairs of locations is identified using the W, A and B. In this embodiment, the plurality of pairs of locations is (W, A), (W, B) and (A, B). Further, mileage cost information and ton-mile cost information for each of the plurality of pairs of locations are computed. The ton-mile cost information is cost information incorporating distance travelled by a vehicle and net weight of load in the vehicle over the distance. Furthermore, sets of mass transport vehicle routes are determined between W, A, and B using the plurality of pairs of locations. In this embodiment, each set of mass transport vehicle routes includes one mass transport vehicle route as one vehicle is used for the transportation of the merchandise. For example, the sets of mass transport vehicle routes include a first mass transport vehicle route (W, A, B, W) and a second mass transport vehicle route (W, B, A, W). In addition, trip cost information for each mass transport vehicle route is computed using the mileage cost information and the ton-mile cost information. The trip cost information for each mass transport vehicle route is computed using an equation:

trip cost information=mileage cost information+k*(ton-mile cost information) where k is a weight constant.

Also, the trip cost information of the first mass transport vehicle route is compared with the trip cost information of the second mass transport vehicle route to determine the optimized mass transport vehicle route. Moreover, the second mass transport vehicle route is determined as the optimized mass transport vehicle route as fuel consumption of the vehicle using the second mass transport vehicle route is less than the fuel consumption of the vehicle using the first mass transport vehicle route. For example, the vehicle using the second mass transport vehicle route consumes less fuel, when driving with 500 lb load from B to A, compared to the vehicle using the first mass transport vehicle route, when driving with 1000 lb load from A to B.

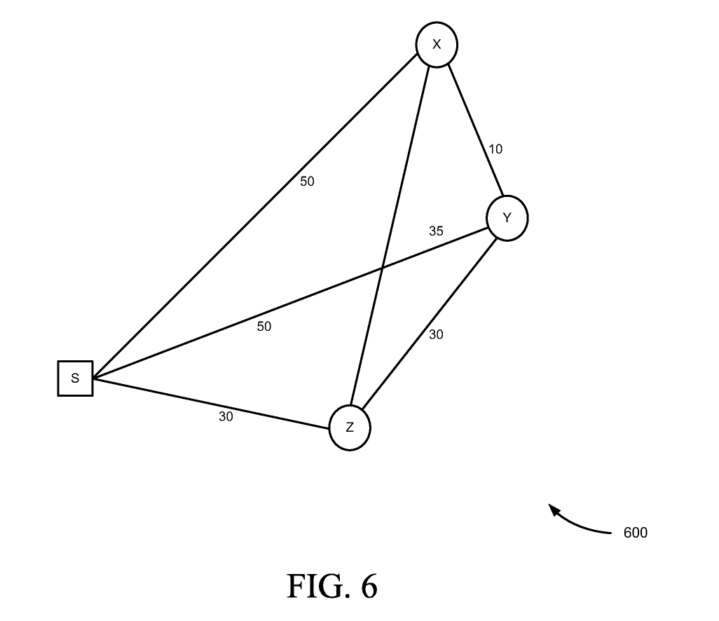

Referring now to FIG. 6, which illustrates another exemplary transportation network 600 for which an optimized set of mass transport vehicle routes is determined, using the process shown in FIG. 1, according to one embodiment. As shown in FIG. 6, three customers (x, y, and z) require merchandise from a warehouse (s). In this embodiment, customer orders of x, y, and z are 90 units, 10 units, and 10 units, respectively. Further, two vehicles, such as a vehicle1 and a vehicle2 are used for transportation of merchandise from s to x, y, and z. Furthermore, capacity of each vehicle is 100 units. Further as shown in FIG. 6, a distance matrix for s, x, y, and z is given below:

$${d}_{ij} = [ \begin{matrix}0 & 50 & 50 & 30 \\ 50 & 0 & 10 & 35 \\ 50 & 10 & 0 & 30 \\ 30 & 35 & 30 & 0\end{matrix} ] i , j = s , x , y , z$$

In operation, a plurality of pairs of locations is identified using the s, x, y, and z. Exemplary plurality of pairs of locations includes (s, x), (s, y), (s, z), (x, y), (y, z), (x, z) and the like. Further, mileage cost information is computed for each of the plurality of pairs of locations. For example, the mileage cost information is computed for each of the plurality of pairs of locations using an equation:

mileage cost information (Mᵢⱼ)=0.1*dᵢⱼ (1)

where dᵢⱼ is the distance matrix, 0.1 is cost per mile.

Further in operation, ton-mile cost information is computed for each of the plurality of pairs of locations. For example, the ton-mile cost information is computed for each of the plurality of pairs of locations using an equation:

ton-mile cost information (TMᵢⱼ)=0.04*dᵢⱼ (2)

where dᵢⱼ is the distance matrix, 0.04 is cost per weight per mile.

Furthermore in operation, sets of mass transport vehicle routes are determined between the s, x, y, and z using the plurality of pairs of locations. In this embodiment, each set of mass transport vehicle routes includes two mass transport vehicle routes as the two vehicles, such as the vehicle1 and vehicle2 are used for the transportation of merchandise. Exemplary sets of mass transport vehicle routes include a first set of mass transport vehicle routes, such as r₁=(s, x, z, s) and r₂=(s, y, s), a second set of mass transport vehicle routes, such as r₁′=(s, x, s) and r₂′=(s, z, y, s) and the like. In one embodiment, r₁ and r₁′ are the mass transport vehicle routes for the vehicle1. Further, r₂ and r₂′ are the mass transport vehicle routes for the vehicle2.

In addition, trip cost information for each set of mass transport vehicle routes is computed. For example, trip cost information for each set of mass transport vehicle routes is computed using an equation:

trip cost information=mileage cost information+k*(ton-mile cost information) where k is a weight constant. (3)

In one embodiment, mileage cost information for the first set of mass transport vehicle routes is

M=sum of mileage cost information of a plurality of pairs of locations in the first set of mass transport vehicle routes.

The plurality of pairs of locations in the first set of mass transport vehicle routes includes (x, y), (y, z), (z, s), (s, y), and (y, s). Further, the mileage cost information for the first set of mass transport vehicle routes is obtained as follows:

M=Mₛₓ+M_{xz}+M_{zs}+M_{sy}+M_{ys}

The mileage cost information for (s, x), computed using the equation (1), is

Mₛₓ=0.1*dₛₓ=0.1*50=5 dollars.

Further, the mileage cost information for (x, z), computed using the equation (1), is

M_{xz}=0.1*d_{xz}=0.1*35=3.5 dollars.

Furthermore, the mileage cost information for (z, s), computed using the equation (1), is

M_{zs}=0.1*d_{zs}=0.1*30=3 dollars.

In addition, the mileage cost information for (s, y), computed using the equation (1), is

M_{sy}=0.1*d_{sy}=0.1*50=5 dollars.

Also, the mileage cost information for (y, s), computed using the equation (1), is

M_{ys}=0.1*d_{ys}=0.1*50=5 dollars.

The mileage cost information for the first set of mass transport vehicle routes is 21.5 dollars.

Further, ton-mile cost information for the first set of mass transport vehicle routes is defined as:

TM=sum of ton-mile cost information of the plurality of pairs of locations in the first set of mass transport vehicle routes.

The TM for the first set of mass transport vehicle routes is obtained using the equation:

TM=TMₛₓ+TM_{xz}+TM_{sy}

The TM_{sx,} computed using the equation (2), is

TMₛₓ=0.04*dₛₓ=0.04*100*50=200 dollars.

Further, the TM_{xz}, computed using the equation (2), is

TM_{xz}=0.04*d_{xz}=0.04*10*35=14 dollars.

Furthermore, the TM_{sy}, computed using the equation (2), is

TM_{sy}=0.04*d_{sy}=0.04*10*50=20 dollars.

The TM for the first set of mass transport vehicle routes is 234 dollars. In addition, the trip cost information for the first set of mass transport vehicle routes, computed using the equation (3), considering k=1

trip cost information (T₁)=21.5+234=255.5 dollars

Similarly, trip cost information(T₂) for the second set of mass transport vehicle routes using mileage cost information for second set of mass transport vehicle routes (M₂) and ton-mile cost information for second set of mass transport vehicle routes (TM₂) is computed using equation:

T₂=M₂+k*TM₂ dollars.

In one embodiment, a plurality of pairs of locations in the second set of mass transport vehicle routes is identified. The plurality of pairs of locations in the second set of mass transport vehicle routes includes (s, x), (x, s), (s, z), (z, y), and (y, s). Further, mileage cost information and ton-mile cost information for each of the plurality of pairs of locations are computed, using the equations (1) and (2), respectively. Furthermore, the M₂ and TM₂ are computed using the mileage cost information and the ton-mile cost information. The M₂ is 21 dollars and the TM₂ is 216 dollars. The T₂, considering k=1, is 237 dollars. Also, it is determined whether T₂ is less than T₁. Moreover, the second set of mass transport vehicle routes is declared as an optimized set of mass transport vehicle routes as the T₂ is less than T₁.

Now referring to FIG. 7, which illustrates a transport management system (TMS) 702 including the mass transport vehicle routing engine 400 to optimize the mass transport vehicle routing based on the additional ton-mile cost information, using the process shown in FIG. 1, according to one embodiment. FIG. 7 and the following discussions are intended to provide a brief, general description of a suitable computing environment in which certain embodiments of the inventive concepts contained herein are implemented.

The TMS 702 includes a processor 704, memory 706, a removable storage 718, and a non-removable storage 720. The TMS 702 additionally includes a bus 714 and a network interface 716. As shown in FIG. 6, the TMS 702 includes access to the computing system environment 700 that includes one or more user input devices 722, one or more output devices 724, and one or more communication connections 726 such as a network interface card and/or a universal serial bus connection.

Exemplary user input devices 722 include a digitizer screen, a stylus, a trackball, a keyboard, a keypad, a mouse and the like. Exemplary output devices 724 include a display unit of the personal computer, a mobile device, and the like. Exemplary communication connections 726 include a local area network, a wide area network, and/or other network.

The memory 706 further includes volatile memory 708 and non-volatile memory 710. A variety of computer-readable storage media are stored in and accessed from the memory elements of the TMS 702, such as the volatile memory 708 and the non-volatile memory 710, the removable storage 718 and the non-removable storage 720. The memory elements include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 704, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 704 also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 704 of the TMS 702. For example, a computer program 712 includes machine-readable instructions capable of optimizing mass transport vehicle routing in the TMS 702, according to the teachings and herein described embodiments of the present subject matter. In one embodiment, the computer program 712 is included on a compact disk-read only memory (CD-ROM) and loaded from the CD-ROM to a hard drive in the non-volatile memory 710. The machine-readable instructions cause the TMS 702 to encode according to the various embodiments of the present subject matter.

As shown, the computer program 712 includes the mass transport vehicle routing engine 400. For example, the mass transport vehicle routing engine 400 can be in the form of instructions stored on a non-transitory computer-readable storage medium. The non-transitory computer-readable storage medium having the instructions that, when executed by the mass transport vehicle routing engine 400, causes the TMS 702 to perform the one or more methods described in FIGS. 1 through 6.

In various embodiments, systems and methods described with reference to FIGS. 1 through 7 propose the mass transport vehicle routing engine for optimizing the mass transport vehicle routing based on the ton-mile cost information. Further, the mass transport routing engine obtains an optimized set of mass transport vehicle routes, for one or more vehicles, for transportation of goods from a starting location to a plurality of customer locations based on the ton-mile cost information. This reduces consumption of fuel by the vehicles. Further, vehicle maintenance and vehicle repair costs are reduced by reducing tire wears of the vehicles and horsepower usage of vehicles engines. Furthermore, adaptability of a user to monitor enterprise operations and diagnosis of financial and management health issues is increased.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for optimizing mass transport vehicle routing based on additional ton-mile cost information, comprising:
identifying a starting location and a plurality of customer locations associated with a warehouse and a plurality of customers, respectively, by a mass transport vehicle routing engine running on the computer;
identifying a plurality of pairs of locations using the starting location and the plurality of customer locations by the mass transport vehicle routing engine running on the computer;
dynamically computing mileage cost information and ton-mile cost information for each of the plurality of pairs of locations by the mass transport vehicle routing engine running on the computer;
dynamically determining, by the mass transport vehicle routing engine running on the computer, sets of mass transport vehicle routes between the starting location and the plurality of customer locations using the plurality of pairs of locations and a number of vehicles to be used;
real-time computing trip cost information for each set of mass transport vehicle routes using the mileage cost information and ton-mile cost information by the mass transport vehicle routing engine running on the computer; and
real-time determining an optimized set of mass transport vehicle routes from the sets of mass transport vehicle routes using the computed trip cost information by the mass transport vehicle routing engine running on the computer.

2. The computer implemented method of claim 1, further comprising:
receiving real-time disruption information associated with the optimized set of mass transport vehicle routes by the mass transport vehicle routing engine running on the computer; and
obtaining a further optimized set of mass transport vehicle routes using the real-time disruption information by the mass transport vehicle routing engine running on the computer.

3. The computer implemented method of claim 2, wherein the starting location and the plurality of customer locations associated with the warehouse and the plurality of customers, respectively, are identified, in real-time, by a mass transport vehicle routing engine running on the computer, based on the real-time disruption information.

4. The computer implemented method of claim 3, wherein the plurality of pairs of locations are identified, in real-time, using the starting location and the plurality of customer locations, by a mass transport vehicle routing engine running on the computer, based on the real-time disruption information.

5. The computer implemented method of claim 4, wherein the real-time disruption information comprises real-time order information, traffic information, accident information, fuel cost, conditions associated with the plurality of customer locations and vehicle conditions.

6. The computer implemented method of claim 1, further comprising:
receiving order information, fleet information and company work rules and regulations by the mass transport vehicle routing engine running on the computer, wherein the order information comprises information selected from the group consisting of a time limit, a customer order and a customer address and wherein the fleet information comprises information selected from the group consisting of a number of available vehicles and vehicle characteristics.

7. The computer implemented method of claim 4, wherein the vehicle characteristics comprise characteristics selected from the group consisting of a vehicle energy type based on energy consumption, a vehicle class, a vehicle size, a vehicle weight, a vehicle capacity, a vehicle energy function, and a vehicle maintenance history.

8. The computer implemented method of claim 4, wherein the plurality of customer locations associated with the plurality of customers is identified by from the received order information.

9. The computer implemented method of claim 1, wherein each set of mass transport vehicle routes comprises one or more mass transport vehicle routes determined based on the number of vehicles used.

10. The computed implemented method of claim 1, wherein the number of vehicles to be used is dynamically computed by the mass transport vehicle routing engine using a number of available vehicles.

11. The computed implemented method of claim 1, wherein the number of vehicles to be used is provided by a user.

12. The computed implemented method of claim 1, wherein each set of mass transport vehicle routes comprises one or more mass transport vehicle routes that cover the plurality of customer locations using the number of vehicles.

13. The computed implemented method of claim 1, wherein the ton-mile cost information is cost information associated with distance travelled by a vehicle and net weight of load carried by the vehicle over the distance.

14. The computer implemented method of claim 1, wherein the trip cost information is computed using an equation:
trip cost information=mileage cost information+k*(ton-mile cost information) where k is a weight constant.

15. The computer implemented method of claim 1, wherein real-time determining the optimized set of mass transport vehicle routes using the computed trip cost information by the mass transport vehicle routing engine running on the computer comprises:
selecting a first set of mass transport vehicle routes and a second set of mass transport vehicle routes from the determined sets of mass transport vehicle routes by the mass transport vehicle routing engine running on the computer;
obtaining the trip cost information associated with the first set of mass transport vehicle routes and the second set of mass transport vehicle routes by the mass transport vehicle routing engine running on the computer;
comparing the trip cost information associated with the first set of mass transport vehicle routes with the trip cost information associated with the second set of mass transport vehicle routes by the mass transport vehicle routing engine running on the computer; and
declaring one of the first set of mass transport vehicle routes and second set of mass transport vehicle routes associated with minimum of the trip cost information as an optimized set of mass transport vehicle routes based on the comparison by the mass transport vehicle routing engine running on the computer.

16. The computer implemented method of claim 15, further comprising:
repeating the steps of selecting, obtaining, comparing and declaring for a next set of mass transport vehicle routes in the sets of mass transport vehicle routes and the optimized set of mass transport vehicle routes by the mass transport vehicle routing engine running on the computer.

17. A transport management system (TMS) for optimizing mass transport vehicle routing based on additional ton-mile cost information, comprising:
a processor;
memory coupled to the processor; and
a mass transport vehicle routing engine residing in the memory, wherein the mass transport vehicle routing engine comprises:
a location identification module to identify a starting location and a plurality of customer locations associated with a warehouse and a plurality of customers, respectively;
a location pair identification module to identify a plurality of pairs of locations using the starting location and the plurality of customer locations;
a mileage cost matrix module to dynamically compute mileage cost information for each of the plurality of pairs of locations;
a ton-mile cost matrix module to dynamically compute ton-mile cost information for each of the plurality of pairs of locations; and
a mass transport vehicle routes planning engine to dynamically determine sets of mass transport vehicle routes between the starting location and the plurality of customer locations using the plurality of pairs of locations and a number of vehicles to be used, compute, in real-time, trip cost information for each set of mass transport vehicle routes using the mileage cost information and ton-mile cost information and determine, in real-time, an optimized set of mass transport vehicle routes from the sets of mass transport vehicle routes using the computed trip cost information.

18. The TMS of claim 17, further comprising:
a real-time disruption information module to store real-time disruption information associated with the optimized set of mass transport vehicle routes; and
a real-time mass transport vehicle routing engine to obtain a further optimized set of mass transport vehicle routes using the real-time disruption information.

19. The TMS of claim 18, wherein the location identification module is configured to identify, in real-time, the starting location and a plurality of customer locations associated with the warehouse and the plurality of customers, respectively, based on the real-time disruption information.

20. The TMS of claim 19, wherein the location pair identification module is configured to identify, in real-time, the plurality of pairs of locations using the starting location and the plurality of customer locations based on the real-time disruption information.

21. The TMS of claim 20, wherein the real-time disruption information comprises real-time order information, traffic information, accident information, fuel cost, vehicle conditions and conditions associated with the plurality of customer locations.

22. The TMS of claim 17, further comprising:
an order information module, a fleet information module and a company work rules and regulations module to store order information, fleet information and company work rules and regulations, respectively, wherein the order information comprises information selected from the group consisting of a time limit, a customer order and a customer address and wherein the fleet information comprises information selected from the group consisting of a number of available vehicles and vehicle characteristics.

23. The TMS of claim 22, wherein the plurality of customer locations associated with the plurality of customers is identified from the received order information.

24. The TMS of claim 22, wherein the mass transport vehicle routes planning engine receives the order information, fleet information and company work rules and regulations from the order information module, fleet information module and company work rules and regulations module.

25. The TMS of claim 22, wherein the vehicle characteristics comprise characteristics selected from the group consisting of a vehicle energy type based on energy consumption, a vehicle class, a vehicle size, a vehicle weight, a vehicle capacity, a vehicle energy function, and a vehicle maintenance history.

26. The TMS of claim 17, wherein each set of mass transport vehicle routes comprises one or more mass transport vehicle routes determined based on the number of vehicles to be used.

27. The TMS of claim 26, wherein the number of vehicles to be used is dynamically computed by the mass transport vehicle routing engine using a number of available vehicles.

28. The TMS of claim 26, wherein the number of vehicles to be used is provided by a user.

29. The TMS of claim 17, wherein each set of mass transport vehicle routes comprises one or more mass transport vehicle routes that cover the plurality of customer locations using the number of vehicles.

30. The TMS of claim 17, wherein the ton-mile cost information is cost information associated with distance travelled by a vehicle and net weight of load carried by the vehicle over the distance.

31. The TMS of claim 17, wherein the trip cost information is computed using an equation:
trip cost information=mileage cost information+k*(ton-mile cost information) where k is a weight constant.

32. The TMS of claim 17, wherein the mass transport vehicle routes planning engine is configured to:
select a first set of mass transport vehicle routes and a second set of mass transport vehicle routes from the sets of mass transport vehicle routes;
obtain the trip cost information associated with the first set of mass transport vehicle routes and the second set of mass transport vehicle routes;
compare the trip cost information associated with the first set of mass transport vehicle routes with the trip cost information associated with the second set of mass transport vehicle routes; and
declare one of the first set of mass transport vehicle routes and second set of mass transport vehicle routes associated with minimum of the trip cost information as an optimized set of mass transport vehicle routes based on the comparison.

33. The TMS of claim 32, the mass transport vehicle routes planning engine is further configured to:
repeat the steps of selecting, obtaining, comparing and declaring for a next set of mass transport vehicle routes in the sets of mass transport vehicle routes and the optimized set of mass transport vehicle routes.

34. At least one non-transitory computer-readable storage medium to optimize mass transport vehicle routing based on additional ton-mile cost information having instructions that, when executed by a computing device, cause the computing device to:
identify a starting location and a plurality of customer locations associated with a warehouse and a plurality of customers, respectively;
identify a plurality of pairs of locations using the starting location and plurality of customer locations;
dynamically compute mileage cost information and ton-mile cost information for each of the plurality of pairs of locations;
dynamically determine sets of mass transport vehicle routes between the starting location and the plurality of customer locations using the plurality of pairs of locations and a number of vehicles to be used;
compute, in real-time, trip cost information for each set of mass transport vehicle routes using the mileage cost information and ton-mile cost information; and
determine, in real-time, an optimized set of mass transport vehicle routes from the sets of mass transport vehicle routes using the computed trip cost information.

35. The at least one non-transitory computer-readable storage medium of claim 34, further comprising:
receiving real-time disruption information associated with the optimized set of mass transport vehicle routes; and
obtaining a further optimized set of mass transport vehicle routes using the real-time disruption information.

36. The at least one non-transitory computer-readable storage medium of claim 34, further comprising:
receiving order information, fleet information and company work rules and regulations, wherein the order information comprises information selected from the group consisting of a time limit, a customer order and a customer address and wherein the fleet information comprises a number of available vehicles and vehicle characteristics.
